(19) United States
(12) Patent Application Publication
(10) Pub. No.: US 2025/0180863 A1
(43) Pub. Date: Jun. 5, 2025

(54) OPTICAL SYSTEM AND IMAGING APPARATUS INCLUDING THE SAME

(71) Applicant: CANON KABUSHIKI KAISHA, Tokyo (JP)

(72) Inventors: KAZUHIKO KAJIYAMA, Tochigi (JP); MASATSUGU NAKANO, Tochigi (JP)

(21) Appl. No.: 18/965,512

(22) Filed: Dec. 2, 2024

(30) Foreign Application Priority Data
Dec. 4, 2023 (JP) 2023-204960

(51) Int. Cl. G02B 9/08; G02B 13/00

(52) U.S. Cl. CPC G02B 9/08; G02B 13/0045

(57) ABSTRACT

An optical system includes, in order from an object side to an image side, a front group with positive refractive power, an aperture stop, and a rear group with positive refractive power, wherein the front group includes, in order from the object side to the image side, a first lens with negative refractive power, a second lens with negative refractive power, a third lens, and a fourth lens with positive refractive power, wherein the rear group includes a cemented lens and a meniscus lens situated closest to the image side, wherein at least one of an object-side surface and an image-side surface of the meniscus lens is an aspherical surface, wherein a spherical surface passing through both edge portions in an effective region of the object-side surface has a concave shape toward the object side in a cross-section including an optical axis, and wherein the specific inequality is satisfied.

### BACKGROUND

### Technical Field

The aspect of the embodiments relates to an optical system suitable for use in imaging apparatuses, such as digital still cameras, digital video cameras, on-vehicle cameras, cameras for mobile phones, monitoring cameras, wearable cameras, or medical cameras.

### Description of the Related Art

Optical systems for use in imaging apparatuses such as on-vehicle cameras are required to have a wide angle of view. Japanese Unexamined Patent Application Publication (Translation of PCT Application) No. 2018-522266 discusses an optical system having a wide angle of view and consisting of, in order from an object side to an image side, seven lenses including a first lens with negative refractive power, a second lens with negative refractive power, a third lens with negative refractive power, and a fourth lens with positive refractive power.

### SUMMARY

According to an aspect of the embodiments, an optical system includes, in order from an object side to an image side, a front group with positive refractive power, an aperture stop, and a rear group with positive refractive power, wherein the front group includes, in order from the object side to the image side, a first lens with negative refractive power, a second lens with negative refractive power, a third lens, and a fourth lens with positive refractive power, wherein the rear group includes a cemented lens and a meniscus lens situated closest to the image side, wherein at least one of an object-side surface and an image-side surface of the meniscus lens is an aspherical surface, wherein a spherical surface passing through both edge portions in an effective region of the object-side surface has a concave shape toward the object side in a cross-section including an optical axis, and wherein the following inequality is satisfied:

0.80≤Rd≤1.00,

where Rd is a value of a ratio of a diameter of a portion with positive power in the effective region to a diameter of the effective region of the image-side surface in a direction perpendicular to the optical axis.

Further features of the disclosure will become apparent from the following description of exemplary embodiments with reference to the attached drawings.

### BRIEF DESCRIPTION OF THE DRAWINGS

FIG. 1 is a schematic diagram illustrating main components of an optical system according to a first embodiment.

FIG. 2 is an aberration chart of the optical system according to the first embodiment.

FIG. 3 is a schematic diagram illustrating main components of an optical system according to a second embodiment.

FIG. 4 is an aberration chart of the optical system according to the second embodiment.

FIG. 5 is a schematic diagram illustrating main components of an optical system according to a third embodiment.

FIG. 6 is an aberration chart of the optical system according to the third embodiment.

FIG. 7 is a schematic diagram illustrating main components of an optical system according to a fourth embodiment.

FIG. 8 is an aberration chart of the optical system according to the fourth embodiment.

FIG. 9 is a diagram illustrating aspherical surface shapes of object-side surfaces of second lenses L2 according to the embodiments.

FIG. 10 is a diagram illustrating aspherical surface shapes of image-side surfaces of meniscus lenses LL according to the embodiments.

FIG. 11 is a schematic diagram illustrating an imaging apparatus according to an exemplary embodiment.

FIG. 12 is a diagram schematically illustrating a moving apparatus according to an exemplary embodiment and an optical characteristic of an optical system.

FIG. 13 is a block diagram illustrating an example of a configuration of a display system according to an exemplary embodiment.

### DESCRIPTION OF THE EMBODIMENTS

Various exemplary embodiments of the disclosure will be described below with reference to the drawings. Each drawing may be depicted at a scale that differs from reality for convenience. In the drawings, corresponding components are assigned the same reference numeral, and redundant descriptions thereof are omitted.

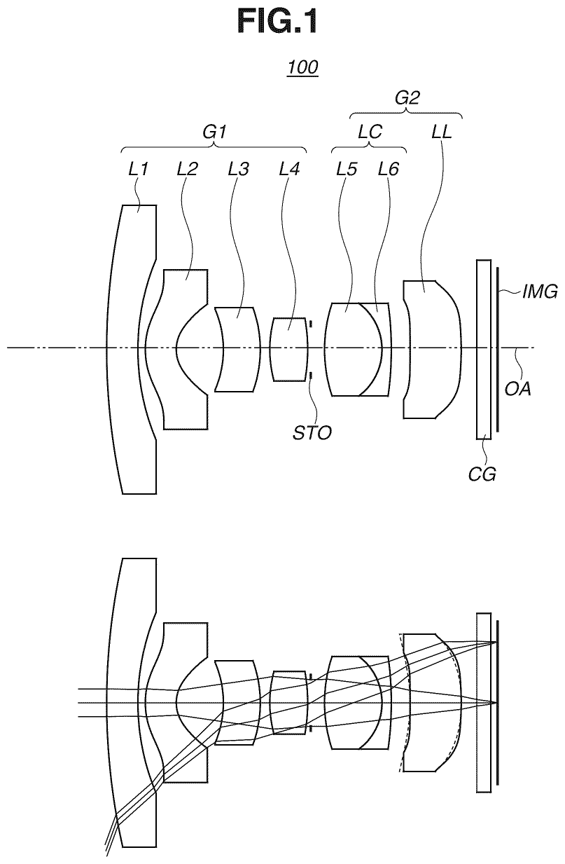

FIGS. 1, 3, 5, and 7 are sectional views each including an optical axis OA and illustrating an optical systems according to first to fourth embodiments, respectively. In each sectional view, the left side is an object side (front side), and the right side is an image side (rear side). Each of the optical systems according to the first to fourth embodiments is an imaging optical system for use in an imaging apparatus, and an imaging plane of an image sensor is disposed at the position of an image plane IMG. An optical block CG disposed on the object side of the image plane IMG is an optical element that does not contribute to image formation of the optical system, such as an optical filter or a cover glass. The optical systems according to the first to fourth embodiments may be used as a projection optical system in a projection apparatus, such as a projector, and in this case, a display surface of a display element, such as a liquid crystal panel, is disposed at the position of the image plane IMG.

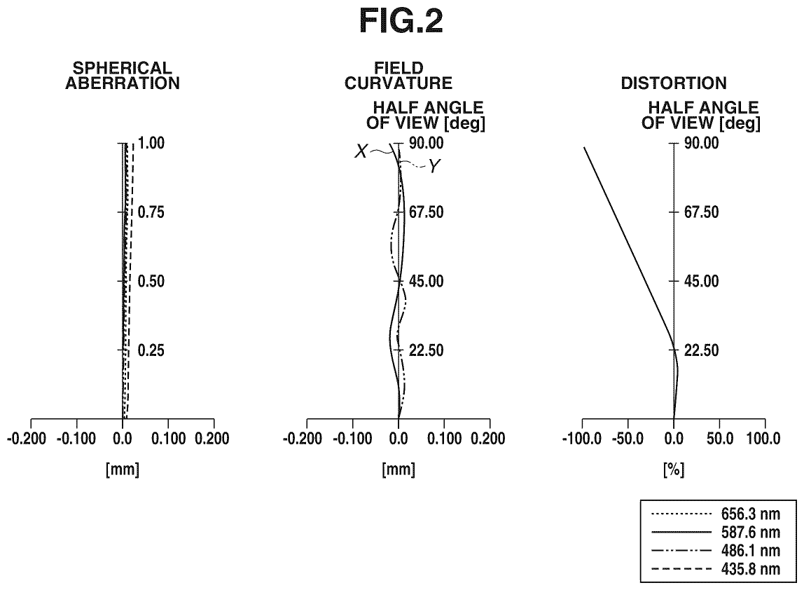

FIGS. 2, 4, 6, and 8 each are a longitudinal aberration chart of the optical systems according to the first to fourth embodiments, respectively. Each longitudinal aberration chart represents, in order from the left, spherical aberrations, field curvatures (astigmatisms), and distortions. In each longitudinal aberration chart, aberrations with respect to 656.3 nm (C-line), 587.6 nm (d-line), 486.1 nm (F-line), and 435.8 nm (g-line) are illustrated with different lines.

Next, features of the optical systems according to the first to fourth embodiments will be described in detail below.

The optical systems according to the first to fourth embodiments each consist of, in order from the object side to the image side, a front group G1 with positive refractive power, an aperture stop STO, and a rear group G2 with positive refractive power. The optical systems without the optical block CG will be discussed below. The front group G1 comprises, in order from an object side to an image side, a first lens L1 with negative refractive power, a second lens L2 with negative refractive power, a third lens L3, and a fourth lens L4 with positive refractive power. The rear group G2 consists of a cemented lens LC and a meniscus lens LL (final lens) disposed closest to the image plane IMG. The lenses herein refer to optical elements with refractive power and do not include optical elements without refractive power, such as parallel plate glass.

In the optical systems according to the first to fourth embodiments, the front group G1 and the rear group G2 both have positive refractive power, and the front group G1 employs the above-described configuration, so that a wide angle of view is achieved while the total length is reduced. With the rear group G2 employing the above-described configuration, field curvatures and magnification chromatic aberrations resulting from widening the angle of view of the optical system are effectively corrected. Especially, with the rear group G2 consisting of the two lenses that are the cemented lens LC and the meniscus lens LL, the various aberrations described above are corrected while the total length and weight from increasing is prevented.

According to the first to fourth embodiments, at least one of the object- and image-side surfaces of the meniscus lens LL is an aspherical surface. Providing the aspherical surface to the meniscus lens LL serving as the final lens disposed closest to the image plane IMG in the optical system facilitates correction of field curvatures resulting from widening the angle of view of the optical system. This beneficial effect can be produced with only one of the object- and image-side surfaces of the meniscus lens LL being an aspherical surface, in one embodiment, the image-side surface that is the final lens surface in the optical system be an aspherical surface as described below. In order to provide additional degrees of freedom in the design of the meniscus lens LL while preventing abrupt changes in aspherical surface shape, in another embodiment, both of the object- and image-side surfaces are aspherical surfaces.

The bottom diagram in FIG. 1 illustrates an outermost off-axis light beam that reaches a maximum off-axis image height and an on-axis light beam that reaches an on-axis image height on the sectional view of the optical system according to the first embodiment in the top diagram in FIG. 1. In the bottom diagram in FIG. 1, only the outermost off-axis light beams that reach the maximum off-axis image height on one side of the optical axis OA are illustrated, and the outermost off-axis light beams that reach the maximum off-axis image height on the other side of the optical axis OA are omitted. In the bottom diagram in FIG. 1, only principal rays that pass through the center of the aperture stop STO and marginal rays (upper and lower rays) that are the outermost light beams are illustrated, and others are omitted. In the bottom diagram in FIG. 1, best-fit spherical surfaces that correspond to the object- and image-side surfaces of the meniscus lens LL are indicated with dashed lines. The best-fit spherical surfaces refer to spherical surfaces (approximate spherical surfaces of the aspherical surfaces) that pass through both edge portions of an effective region of lens surfaces. The effective region refers to a region through which effective light beams that contribute to image formation pass, and both edge portions of the effective region are portions through which marginal rays of the outermost off-axis light beams pass.

According to the first to fourth embodiments, the best-fit spherical surface in the effective region of an object-side surface of the meniscus lens LL is concave toward the object side in the cross-section including the optical axis OA. This shape facilitates positioning the edge portions (lens periphery) of the meniscus lens LL in a radial direction apart from the image plane IMG, which facilitates preventing the holding member for holding the meniscus lens LL from interfering with the image sensor. In one embodiment, the best-fit spherical surface in the effective region of the image-side surface of the meniscus lens LL is convex toward the image side. This further facilitates preventing the holding member from interfering with the image sensor.

Furthermore, the optical systems according to the first to fourth embodiments satisfy the following inequality (0):

$$0.8 \leq Rd \leq 1 \text{.00} , \qquad ( 0 )$$

where Rd is a value of a ratio of a diameter of a portion with positive power in the effective region to a diameter of the effective region of the image-side surface of the meniscus lens LL in a direction perpendicular to the optical axis OA.

Inequality (0) indicates that the proportion of the portion with positive power in the effective region of the image-side surface of the meniscus lens LL is large. By satisfying inequality (0), formation of the image-side surface of the meniscus lens LL is facilitated. In a case where inequality (0) is not satisfied, abrupt changes in the shape of the image-side surface of the meniscus lens LL occur, which makes it difficult to maintain high surface precision during molding.

Furthermore, in one embodiment, the following inequality (0a) is satisfied:

$$0.85 \leq Rd \leq 1. . \qquad ( 0 a )$$

In another embodiment, the following inequality (0b) is satisfied:

$$0.9 \leq Rd \leq 1 \text{.00} . \qquad ( 0 b )$$

In one embodiment, the effective region of the image-side surface of the meniscus lens LL be convex throughout the entire region from on-axis to the outermost off-axis, as in the first embodiment. In other words, the following equality (0c) is satisfied:

$$Rd = 1. . \qquad ( 0 c )$$

This results in the concave and convex shapes of the image-side surface of the meniscus lens LL remaining unchanged from the off-axis to the outermost off-axis, which further facilitates lens surface formation.

The beneficial effect of the disclosure is obtained if the optical systems according to the first to fourth embodiments satisfy at least the configurations described above, and a configuration in which, for example, the front group G1 further comprises a lens other than the first lens L1 to the fourth lens L4 (a configuration comprising five or more lenses) may be employed. However, for size reduction of the entire system, the front group G1 consists of four lenses. Whether the third lens L3 is to have positive refractive power or negative refractive power can be determined based on the specifications of each optical system. According to the first to fourth embodiments, the meniscus lens LL is a positive lens with positive power. However, the meniscus lens LL may be a negative lens with negative power, as appropriate. In one embodiment, the meniscus lens LL is a positive lens in order to achieve both a wide angle of view and excellent optical performance based on the above-described configurations.

For imaging apparatuses, such as on-vehicle cameras described below, both a wide angle of view and increased imaging magnification in the vicinity of the optical axis (central region) are demanded. For example, in a case where an imaging apparatus is disposed at the rear of a movable apparatus (vehicle), an enlarged image of an image corresponding to a central region that is to be a main region of interest may be displayed on an electronic rearview mirror, and the entire image including regions (peripheral regions) other than the central region may be displayed on an in-vehicle display. For this form, the optical system has different imaging magnifications (focal lengths) for the central region and the regions other than the central region. Thus, in one embodiment, an aspherical surface is provided to the first lens L1, which is the lens disposed closest to the object and in which the light rays from the object are greatly separated from each other. However, since the lens disposed closest to the object is larger in diameter than the other lenses, it is difficult to mold the aspherical surface.

Thus, in one embodiment, the object-side surface (object-side lens surface) of the second lens L2 is an aspherical surface. With this configuration, light rays from peripheral portions in the radial direction in the light beams from the first lens L1 are greatly refracted toward the optical axis OA by the object-side surface of the second lens L2.

This facilitates differentiation between imaging magnifications in the central region and the peripheral regions of the optical system.

In this case, the object-side surface of the second lens L2 is an aspherical surface with an inflection point in the cross-section including the optical axis OA. This facilitates achievement of a wide angle of view and increased imaging magnification in the central region while reducing the number of lenses of the optical system.

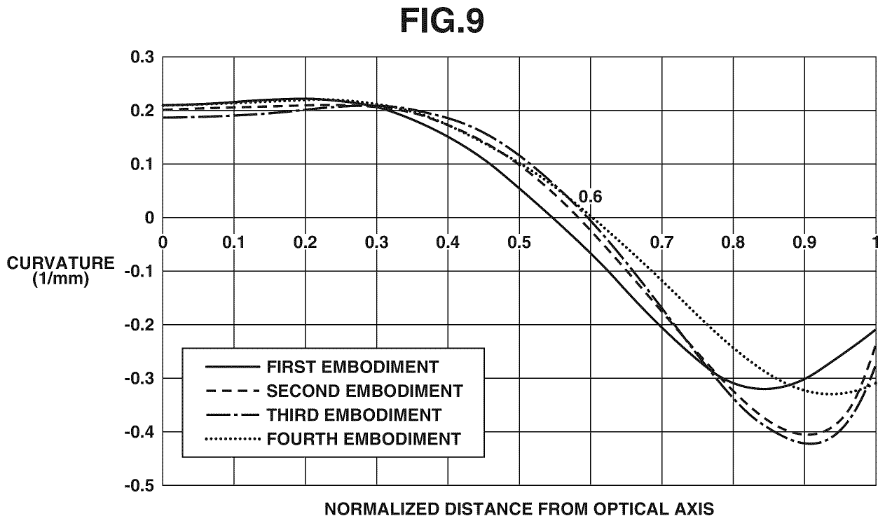

FIG. 9 illustrates aspherical surface shapes of the object-side surfaces of the second lenses L2 according to the first to fourth embodiments. In FIG. 9, the horizontal axis represents radial positions of the object-side surface of the second lens L2 in the cross-section including the optical axis OA, and the vertical axis represents curvatures [1/mm] of the object-side surface of the second lens L2. More specifically, FIG. 9 illustrates a graph plotting the curvature at each position on the object-side surface of the second lens L2. The numerical values on the horizontal axis represent the distances (normalized distances) from the optical axis OA to positions within an effective diameter of the object-side surface of the second lens L2 when the distance from the optical axis OA to the position of the effective diameter (maximum effective diameter) is normalized to 1.

In one embodiment, the object-side surfaces of the second lenses L2 are aspherical surfaces so that each graph in FIG. 9 representing the curvature with respect to the distance from the optical axis OA includes an extremum. As illustrated in FIG. 9, the graphs according to the first to fourth embodiments each include at least one extremum. This makes it possible to highlight the difference in imaging magnification between the central region and the peripheral regions of the optical system. Specifically, the imaging magnification can be set larger in the central region as compared with the peripheral regions, which makes it possible to improve the visibility of images for the user of the imaging apparatus. This beneficial effect is obtained in a case where the above-described graph includes one extremum, but the effect becomes more pronounced by including a plurality of extrema. According to the first to fourth embodiments, the above-described graph includes a first extremum (maximum value) and a second extremum (minimum value).

In one embodiment, the optical systems according to the first to fourth embodiments each satisfy the following inequality (1):

$$0.05 \leq E 1 \leq 0.5 , \qquad ( 1 )$$

where E1 is the normalized distance from the optical axis OA to the position corresponding to the first extremum on the object-side surface of the second lens L2.

Inequality (1) defines a suitable position of the first extremum. Satisfying inequality (1) facilitates increase of a focal length of the central region of the optical system. Failing to satisfy inequality (1) is undesirable because it becomes difficult to set suitable imaging magnifications for the central region and the peripheral regions.

Furthermore, desirably, the following inequality (1a) is satisfied:

$$0.08 \leq E 1 \leq 0.45 . \qquad ( 1 a )$$

In another embodiment, the following inequality (1b) is satisfied:

$$0.1 \leq E 1 \leq 0 \text{.40} . \qquad ( 1 b )$$

In one embodiment, the optical systems according to the first to fourth embodiments each satisfy the following inequality (2):

$$0.6 \leq E 2 \leq 0.98 , \qquad ( 2 )$$

where E2 is the normalized distance from the optical axis OA to the position corresponding to the second extremum on the object-side surface of the second lens L2.

Inequality (2) defines a suitable position of the second extremum. Satisfying inequality (2) facilitates achievement of both a size reduction and a wide angle of view of the optical system while highlighting the difference in imaging magnification between the central region and the peripheral regions. Failing to satisfy inequality (2) is undesirable because it becomes difficult to set suitable imaging magnifications for the central region and the peripheral regions.

Furthermore, in one embodiment, the following inequality (2a) is satisfied:

$$0.65 \leq E 2 \leq 0 \text{.96} . \qquad ( 2 a )$$

In another embodiment, the following inequality (2b) is satisfied:

$$0.7 \leq E 2 \leq 0 \text{.95} . \qquad ( 2 b )$$

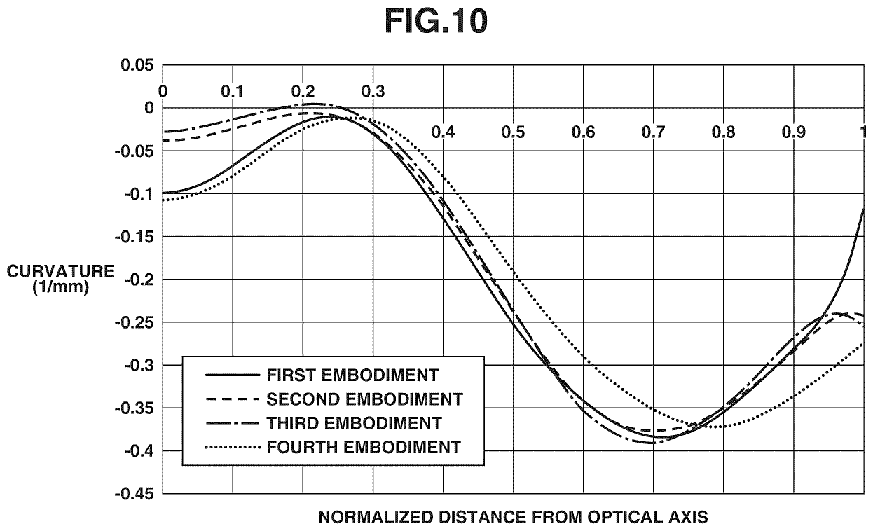

FIG. 10 illustrates aspherical surface shapes of the image-side surfaces (convex surfaces) of the meniscus lenses LL according to the first to fourth embodiments, as in FIG. 9. In one embodiment, the image-side surfaces of the meniscus lenses LL are aspherical surfaces so that each graph in FIG. 10 representing the curvature with respect to the distance from the optical axis OA includes an extremum. As illustrated in FIG. 10, the graphs according to the first to fourth embodiments each include a third extremum (maximum value). This makes it possible to correct field curvatures that occur when the difference in imaging magnification between the central region and the peripheral regions of the optical system is highlighted, which facilitates achieving high optical performance from on-axis to the outermost off-axis.

In one embodiment, the optical systems according to the first to fourth embodiments each satisfy the following inequality (3):

$$0.05 \leq E 3 \leq 0 \text{.50} , \qquad ( 3 )$$

where E3 is the normalized distance from the optical axis OA to the position corresponding to the third extremum on the image-side surface of the meniscus lens LL.

Inequality (3) defines a suitable position of the third extremum on the image-side surface of the meniscus lens LL, which is the final lens surface. Satisfying inequality (3) facilitates preventing variations in field curvature from on-axis to the outermost off-axis in the optical system. Failing to satisfy inequality (3) is undesirable because it becomes difficult to prevent variations in field curvature from on-axis to the outermost off-axis.

Furthermore, in one embodiment, the following inequality (3a) is satisfied:

$$0.1 \leq E 3 \leq 0 \text{.45} . \qquad ( 3 a )$$

In another embodiment, the following inequality (3b) is satisfied:

$$0.15 \leq E 3 \leq 0 \text{.40} . \qquad ( 3 b )$$

In one embodiment, the shape of the second lens L2 on the optical axis OA is a convex meniscus shape toward the object side, as described below. In this case, the meniscus lens LL having the convex meniscus shape toward the image side is approximately symmetrical to the second lens L2 relative to the aperture stop STO. Thus, in order to effectively correct field curvatures caused by the second lens L2 using the meniscus lens LL, the extrema on the aspherical surfaces of the second lens L2 and the meniscus lens LL are also at positions that are approximately symmetrical relative to the aperture stop STO. Therefore, both inequalities (1) and (3) are satisfied.

In one embodiment, the optical systems according to the first to fourth embodiments each satisfy the following inequality (4):

$$3.5 \leq fa 1 / f \leq 1 0. , \qquad ( 4 )$$

where fa1 is a focal length of an air lens between the first lens L1 and the second lens L2, and f is a focal length of the optical system (entire system).

By satisfying inequality (4), a strong positive power (refractive power) (with a high absolute value) is imparted to the air lens formed by the first lens L1 and the second lens L2, which makes it possible to increase the imaging magnification in the central region of the optical system. Falling below the lower limit of inequality (4) is undesirable because the positive power of the air lens becomes excessively strong, which may cause significant changes in the optical performance of the optical system in a case where the lens alignment is shifted due to manufacturing errors. Exceeding the upper limit of inequality (4) is also undesirable because the positive power of the air lens becomes excessively weak, which makes it difficult to increase the imaging magnification in the central region of the optical system.

Furthermore, in one embodiment, the following inequality (4a) is satisfied:

$$3.7 \leq fa 1 / f \leq 9.5 . \qquad ( 4 a )$$

In another embodiment, the following inequality (4b) is satisfied:

$$4. \leq fa 1 / f \leq 9. . \qquad ( 4 b )$$

In one embodiment, the optical systems according to the first to fourth embodiments each satisfy the following inequality (5):

$$0.4 \leq fG 1 / fG 2 \leq 3.5 , \qquad ( 5 )$$

where fG1 is a focal length of the front group G1, and fG2 is a focal length of the rear group G2.

By satisfying inequality (5), the powers of the front group G1 and the rear group G2 are appropriately set, which makes it possible to further reduce the size of the optical system. Falling below the lower limit of inequality (5) is undesirable because the power of the front group G1 becomes excessively strong, which may cause significant changes in the optical performance of the optical system in a case where the lens alignment is shifted due to manufacturing errors. Exceeding the upper limit of inequality (5) is also undesirable because the power of the front group G1 becomes excessively weak, which makes it difficult to further reduce the size of the optical system.

Furthermore, in one embodiment, the following inequality (5a) is satisfied:

$$0.45 \leq fG 1 / fG 2 \leq 3.45 . \qquad ( 5 a )$$

In another embodiment, the following inequality (5b) is satisfied:

$$0.5 \leq fG 1 / fG 2 \leq 3 \text{.40} . \qquad ( 5 b )$$

In one embodiment, the optical systems according to the first to fourth embodiments each satisfy the following inequality (6):

$$- 1.50 \leq ( R 2 + R 1 ) / ( R 2 - R 1 ) \leq - 4 \text{.00} , \qquad ( 6 )$$

where R1 is a radius of curvature of the best-fit spherical surface in the effective region of the object-side surface of the meniscus lens LL, and R2 is a radius of curvature of the best-fit spherical surface in the effective region of the image-side surface of the meniscus lens LL.

Inequality (6) defines a desirable shape (shape factor) of the meniscus lens LL. Falling below the lower limit of inequality (6) is undesirable because the aperture angle of the meniscus lens LL becomes excessively large, which may make it difficult to process the aspherical surface of the meniscus lens LL or may increase unwanted light reflecting from the aspherical surface. Exceeding the upper limit of inequality (6) is also undesirable because abrupt changes may occur in the surface shape of the meniscus lens LL, which makes it difficult to maintain high surface precision during molding.

Furthermore, in one embodiment, the following inequality (6a) is satisfied:

$$- 1.7 \leq ( R 2 + R 1 ) / ( R 2 - R 1 ) \leq - 3.8 . \qquad ( 6 a )$$

In another embodiment, the following inequality (6b) is satisfied:

$$- 1.9 \leq ( R 2 + R 1 ) / ( R 2 - R 1 ) \leq - 3.6 . \qquad ( 6 b )$$

In one embodiment, the optical systems according to the first to fourth embodiments each satisfy the following inequality (7):

$$1. \leq fLC / f \leq 6. , \qquad ( 7 )$$

where fLC is a focal length of the cemented lens LC.

Satisfying inequality (7) makes it possible to effectively correct field curvatures and astigmatisms throughout the entire region of the wide angle of view. Falling below inequality (7) is undesirable because the positive power of the cemented lens LC becomes excessively strong, which makes it easier for higher-order aberrations to occur. Exceeding the upper limit of inequality (4) is also undesirable because the positive power of the cemented lens LC becomes excessively weak, which may lead to insufficient correction of field curvatures or astigmatisms.

Furthermore, in one embodiment, the following inequality (7a) is satisfied:

$$1.1 \leq fLC / f \leq 5.9 . \qquad ( 7 a )$$

In another embodiment, the following inequality (7b) is satisfied:

$$1.2 \leq fLC / f \leq 5.8 . \qquad ( 7 b )$$

In one embodiment, the optical systems according to the first to fourth embodiments each satisfy the following inequality (8):

$$- 2.2 \leq Ds / rLC \leq - 0.6 , \qquad ( 8 )$$

where rLC is a radius of curvature of a bonding surface of the cemented lens LC, and Ds is a distance from the aperture stop STO to the bonding surface of the cemented lens LC.

By satisfying inequality (8), the bonding surface of the cemented lens LC becomes concentric relative to the aperture stop STO, which makes it possible to prevent halos from occurring throughout the entire region of the wide angle of view. Falling below the lower limit of inequality (8) is undesirable because the radius of curvature of the bonding surface of the cemented lens LC becomes excessively small, which makes it easier for higher-order aberrations to occur. Exceeding the upper limit of inequality (8) is also undesirable because the radius of curvature of the bonding surface of the cemented lens LC becomes excessively large, which may lead to insufficient correction of halos.

Furthermore, in one embodiment, the following inequality (8a) is satisfied:

$$- 2.1 \leq Ds / rLC \leq - 0.7 . \qquad ( 8 a )$$

In another embodiment, the following inequality (8b) is satisfied:

$$- 2. \leq Ds / rLC \leq - 0.8 . \qquad ( 8 b )$$

In one embodiment, the optical systems according to the first to fourth embodiments each satisfy the following inequality (9):

$$2. \leq fLL / f \leq 22. , \qquad ( 9 )$$

where fLL is a focal length of the meniscus lens LL.

By satisfying inequality (9), a suitable positive power is imparted to the meniscus lens LL, which makes it possible to prevent field curvatures from occurring throughout the entire region of the wide angle of view and achieve excellent telecentricity. Falling below the lower limit of inequality (9) is undesirable because the power of the meniscus lens LL becomes excessively large, which makes it difficult to correct field curvatures. Exceeding the upper limit of inequality (9) is also undesirable because the power of the meniscus lens LL becomes excessively small, which makes it difficult to achieve excellent telecentricity.

Furthermore, in one embodiment, the following inequality (9a) is satisfied:

$$2.2 \leq fLL / f \leq 21. . \qquad ( 9 a )$$

In another embodiment, the following inequality (9b) is satisfied:

$$2.4 \leq fLL / f \leq 20. . \qquad ( 9 b )$$

In one embodiment, on the optical axis OA, the first lens L1 and the second lens L2 each have a convex meniscus shape toward the object side, the third lens L3 has a concave shape toward the object side, and the fourth lens L4 has a biconvex shape. With this configuration, the angle of incidence of each light ray on the rear group G2 is reduced, and changes in optical performance due to alignment errors (manufacturing errors) or the like of each lens are prevented. In another embodiment, the shapes of the lenses other than the shapes on the optical axis OA are also configured as described above.

Specifically, each of the first lens L1 and the second lens L2 is a meniscus lens (negative meniscus lens) having a convex shape toward the object side, the third lens L3 is a lens having a concave shape toward the object side, and the fourth lens L4 is a biconvex lens.

In one embodiment, the cemented lens LC of the rear group G2 further includes, in order from the object side to the image side, a positive lens and a negative lens in order to facilitate reduction of magnification chromatic aberrations. Furthermore, on the optical axis OA, the positive lens of the cemented lens LC has a biconvex shape, and the negative lens of the cemented lens LC has a convex meniscus shape toward the image side. This makes it possible to effectively correct magnification chromatic aberrations while reducing the size of the cemented lens LC. In one embodiment, the shapes of the lenses other than the shapes on the optical axis OA are also configured as described above. Specifically, the positive lens of the cemented lens LC is a biconvex lens, and the negative lens of the cemented lens LC is a meniscus lens having a convex shape toward the image side. The cemented lens LC may consist of three or more lenses. However, the cemented lens LC consists of two lenses, for size reduction of the entire system and facilitation of manufacturing.

Detailed configurations of the optical systems according to the first to fourth embodiments will be described below.

### First Embodiment

As illustrated in FIG. 1, an optical system 100 according to the first embodiment consists of, in order from the object side to the image side, the first lens L1, the second lens L2, the third lens L3, the fourth lens LA, the aperture stop STO, the cemented lens LC, and the meniscus lens LL. A light beam from an object (not illustrated) is focused onto the image plane IMG through the lenses and a cover glass CG, thereby forming an image of the object. The optical system 100 according to the present embodiment has a total angle of view of 180° (with a half angle of view of)+90°, which is sufficiently wide, and a focal length (central focal length) of 4.4 mm on the optical axis OA, which is sufficiently long.

According to the present embodiment, the third lens L3 has negative refractive power, and the cemented lens LC consists of, in order from the object side to the image side, a positive lens L5 and a negative lens L6. The second lens L2 and the meniscus lens LL each have an aspherical surface. Specifically, the object-side surfaces and the image-side surfaces of the second lens L2 and the meniscus lens LL are each an aspherical surface, and the object-side surface of the second lens L2 and the image-side surface of the meniscus lens LL are each an aspherical surface including an inflection point in the cross-section including the optical axis OA.

As illustrated in FIG. 2, spherical aberrations and field curvatures are effectively corrected in the optical system 100 according to the present embodiment. Distortions in the peripheral regions increase as the angle of view (image height) increases, whereas distortions in the central region are relatively small. This makes it possible to achieve a high resolution in the central region as compared with the peripheral regions, which makes it possible to improve the visibility of images for the user of the imaging apparatus.

### Second Embodiment

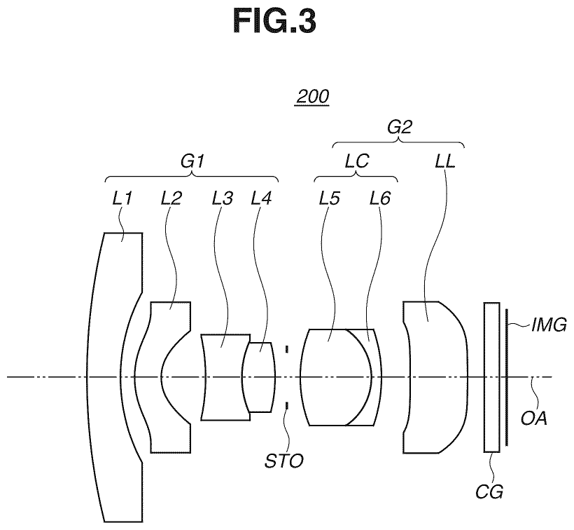

As illustrated in FIG. 3, an optical system 200 according to the second embodiment consists of, in order from the object side to the image side, the first lens L1, the second lens L2, the third lens L3, the fourth lens L4, the aperture stop STO, the cemented lens LC, and the meniscus lens LL. According to the present embodiment, the third lens L3 has negative refractive power, and the cemented lens LC consists of, in order from the object side to the image side, the positive lens L5 and the negative lens L6, as in the first embodiment. However, the present embodiment differs from the first embodiment in that the third lens L3 and the fourth lens L4 are bonded together to form a cemented lens. The optical system 200 according to the present embodiment has a total angle of view of 180° (with a half angle of view of)+90°, which is sufficiently wide, and a focal length of 4.6 mm on the optical axis OA, which is sufficiently long.

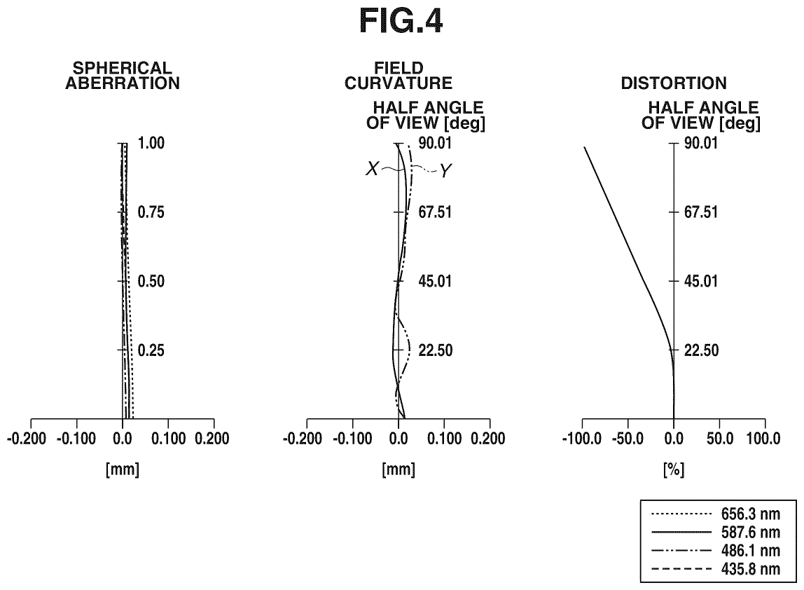

As illustrated in FIG. 4, spherical aberrations and field curvatures are effectively corrected in the optical system 200 according to the present embodiment. Distortions in the peripheral regions increase as the angle of view increases, whereas distortions in the central region are relatively small.

### Third Embodiment

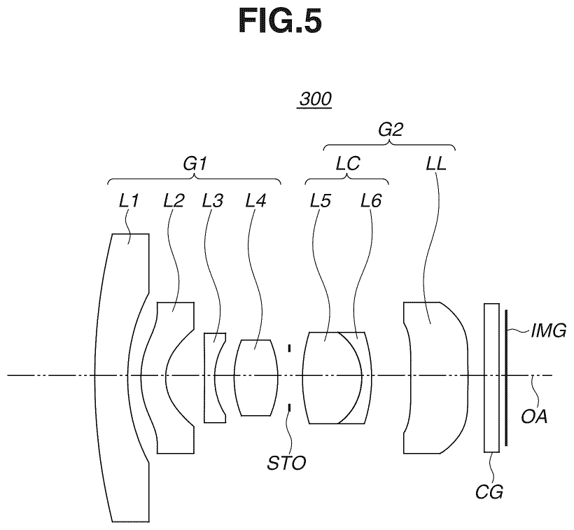

As illustrated in FIG. 5, an optical system 300 according to the third embodiment consists of, in order from the object side to the image side, the first lens L1, the second lens L2, the third lens L3, the fourth lens L4, the aperture stop STO, the cemented lens LC, and the meniscus lens LL. The optical system 300 according to the present embodiment has a total angle of view of 180° (with a half angle of view of)+90°, which is sufficiently wide, and a focal length of 4.5 mm on the optical axis OA, which is sufficiently long.

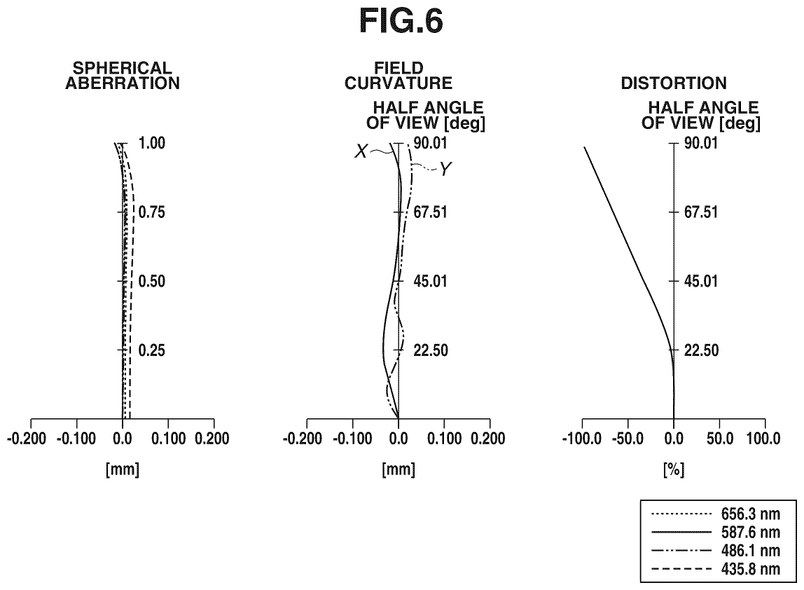

As illustrated in FIG. 6, spherical aberrations and field curvatures are effectively corrected in the optical system 300 according to the present embodiment. Distortions in the peripheral regions increase as the angle of view increases, whereas distortions in the central region are relatively small.

### Fourth Embodiment

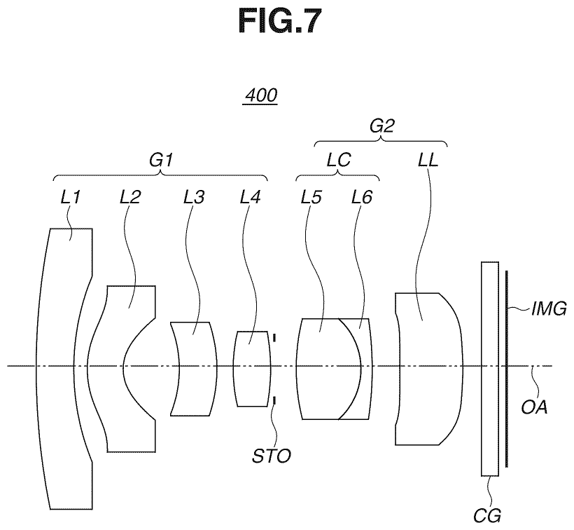

As illustrated in FIG. 7, an optical system 400 according to the fourth embodiment consists of, in order from the object side to the image side, the first lens L1, the second lens L2, the third lens L3, the fourth lens L4, the aperture stop STO, the cemented lens LC, and the meniscus lens LL. The optical system 400 according to the present embodiment has a total angle of view of 120° (with a half angle of view of)+60°, which is sufficiently wide, and a focal length of 4.4 mm on the optical axis OA, which is sufficiently long.

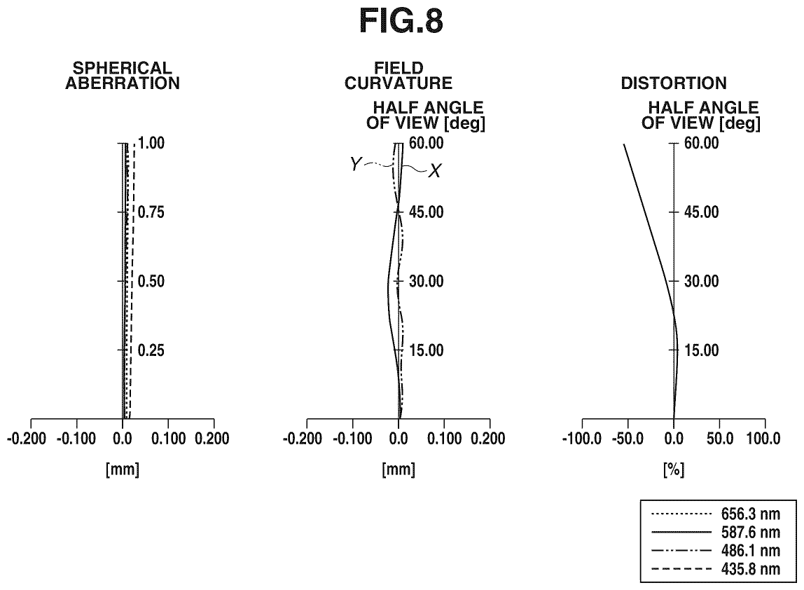

As illustrated in FIG. 8, spherical aberrations and field curvatures are effectively corrected in the optical system 400 according to the present embodiment. Distortions in the peripheral regions increase as the angle of view increases, whereas distortions in the central region are relatively small.

First to fourth numerical examples for the first to fourth embodiments described above will be described below. In each numerical example, each surface number indicates the order of the corresponding optical surface counted from the object plane, r [mm] indicates the radius of curvature of the i-th optical surface, and d [mm] indicates the distance (distance on the optical axis) between the i-th optical surface and the (i+1)-th optical surface. Further, nd indicates the refractive index of a medium between the i-th surface and the (i+1)-th surface for the d-line, and νd indicates the Abbe number of the medium based on the d-line. The Abbe number νd is the value defined by the following equation:

$$vd = ( nd - 1 ) / ( nF - nC ) ,$$

where nF, nd, and nC indicate refractive indices for the F-line, the d-line, and the C-line, respectively.

In each numerical example, an asterisk symbol (*) is added at the end of each surface number of aspherical surfaces. In the numerical values, “E±P” indicates “×10±P”. The shape of each aspherical surface is represented by the following Equation 1:

$$z = \frac{{ch}^{2}}{1 + \sqrt{1 - ( 1 + k ) {c}^{2} {h}^{2}}} + {Ah}^{4} + {Bh}^{6} + {Ch}^{8} + {Dh}^{10} + {Eh}^{12} + {Fh}^{14} + {Gh}^{16} + {Hh}^{18} + {Ih}^{20} + … , \qquad Equation 1$$

where z is an amount of displacement from a surface vertex in the optical axis direction, h is a height from the optical axis OA in a direction perpendicular to the optical axis direction, c is a curvature (reciprocal of the radius of curvature r), k is a conic coefficient, and A, B, C, D, E, F, G, H, I . . . are aspherical surface coefficients.

The optical systems according to the numerical examples are each a monofocal optical system in which the focal length is fixed (no zooming is performed) and employ a configuration that does not perform focusing. Specifically, the distances between the lenses of the optical systems according to the numerical examples are always fixed. This makes it possible to avoid variations in optical performance that are caused by movement of the lenses. However, the optical systems may be configured to perform at least one of zooming and focusing as appropriate, and in order to do so, the distances between the lenses may be set variable.

### First Numerical Example

Various Data

| Central Focal Length | 4.4 mm |
|---|---|
| Fno | 2.8 |
| Half Angle of View | ±90° |

Surface Data

| Surface | | | | |
|---|---|---|---|---|
| Number | r | d | Nd | νd |
| 1 | 38.73 | 2.00 | 1.703 | 52.4 |
| 2 | 13.85 | 0.47 | | |
| 3* | 4.75 | 1.98 | 1.583 | 59.5 |
| 4* | 2.12 | 3.01 | | |
| 5 | −6.05 | 2.36 | 1.516 | 64.1 |
| 6 | −7.30 | 0.61 | | |
| 7 | 7.07 | 2.42 | 1.589 | 61.1 |
| 8 | −10.46 | 0.20 | | |
| 9(STO) | ∞ | 0.88 | | |
| 10 | 8.67 | 3.67 | 1.618 | 63.3 |
| 11 | −3.47 | 0.60 | 1.855 | 24.8 |
| 12 | −19.49 | 1.20 | | |
| 13* | −173.70 | 3.27 | 1.583 | 59.5 |
| 14* | −10.12 | 0.99 | | |
| 15 | ∞ | 0.90 | 1.560 | 56.0 |
| 16 | ∞ | 0.44 | | |

Aspherical Surface Coefficient

| Surface | | | | | | | | |
|---|---|---|---|---|---|---|---|---|
| Number | K | A | B | C | D | E | F | G |
| 3 | −1.062E+00 | 4.190E−03 | −7.401E−04 | 2.644E−05 | −3.245E−07 | 1.410E−08 | −8.852E−10 | 1.518E−11 |
| 4 | −1.188E+00 | 1.867E−02 | −3.569E−03 | −1.968E−04 | 2.351E−04 | −5.041E−05 | 4.898E−06 | −1.807E−07 |
| 13 | 0.000E+00 | 2.879E−03 | −3.671E−03 | 1.155E−03 | −2.272E−04 | 2.619E−05 | −1.652E−06 | 4.450E−08 |
| 14 | 0.000E+00 | 2.115E−02 | −7.507E−03 | 1.246E−03 | −1.282E−04 | 8.028E−06 | −2.791E−07 | 4.130E−09 |

### Second Numerical Example

Various Data

| Central Focal Length | 4.6 mm |
|---|---|
| Fno | 2.8 |
| Half Angle of View | ±90° |

Surface Data

| Surface | | | | |
|---|---|---|---|---|
| Number | r | d | Nd | νd |
| 1 | 34.16 | 2.00 | 1.703 | 52.4 |
| 2 | 10.12 | 0.85 | | |
| 3* | 4.94 | 1.58 | 1.583 | 59.5 |
| 4* | 2.40 | 2.64 | | |
| 5 | −10.94 | 2.16 | 1.517 | 52.4 |
| 6 | 5.02 | 1.98 | 1.772 | 49.6 |
| 7 | −8.04 | 0.70 | | |
| 8 | ∞ | 0.80 | | |
| 9(STO) | 7.37 | 4.24 | 1.595 | 67.7 |
| 10 | −3.32 | 0.60 | 1.847 | 23.8 |
| 11 | −8.36 | 1.71 | | |
| 12* | −200.01 | 3.42 | 1.583 | 59.5 |
| 13* | −26.62 | 0.99 | | |
| 14 | ∞ | 0.90 | 1.560 | 56.0 |
| 15 | ∞ | 0.44 | | |

AsphericalSurface Coefficient

| Surface | | | | | | | |
|---|---|---|---|---|---|---|---|
| Number | K | A | B | C | D | E | F |
| 3 | −1.911E+00 | 3.430E−03 | −1.352E−04 | −8.797E−05 | 9.512E−06 | −4.015E−07 | 6.462E−09 |
| 4 | −5.240E−01 | 4.738E−03 | 1.946E−03 | −1.705E−03 | 3.806E−04 | −4.009E−05 | 1.686E−06 |
| 12 | 0.000E+00 | 1.790E−04 | −1.349E−03 | 3.218E−04 | −4.507E−05 | 3.156E−06 | −8.814E−08 |
| 13 | 0.000E+00 | 7.993E−03 | −2.816E−03 | 3.189E−04 | −2.039E−05 | 7.057E−07 | −1.027E−08 |

### Third Numerical Example

Various Data

| Central Focal Length | 4.5 mm |
|---|---|
| Fno | 2.8 |
| Half Angle of View | ±90° |

Surface Data

| Surface | | | | |
|---|---|---|---|---|
| Number | r | d | Nd | νd |
| 1 | 33.65 | 2.00 | 1.703 | 52.4 |
| 2 | 10.19 | 0.81 | | |
| 3* | 5.31 | 1.50 | 1.583 | 59.5 |
| 4* | 2.76 | 2.36 | | |
| 5 | −385.85 | 0.62 | 1.516 | 64.1 |
| 6 | 3.84 | 1.19 | | |
| 7 | 5.71 | 2.65 | 1.571 | 53.0 |
| 8 | −5.50 | 0.70 | | |
| 9(STO) | ∞ | 0.80 | | |
| 10 | 8.69 | 3.60 | 1.595 | 67.7 |
| 11 | −3.20 | 0.60 | 1.847 | 23.8 |
| 12 | −8.26 | 2.38 | | |
| 13* | −218.00 | 3.47 | 1.583 | 59.5 |
| 14* | −37.19 | 0.99 | | |
| 15 | ∞ | 0.90 | 1.560 | 56.0 |
| 16 | ∞ | 0.44 | | |

Aspherical Surface Coefficient

| Surface | | | | | | | |
|---|---|---|---|---|---|---|---|
| Number | K | A | B | C | D | E | F |
| 3 | −1.479E+00 | 3.397E−03 | 7.286E−05 | −1.162E−04 | 1.087E−05 | −4.212E−07 | 6.290E−09 |
| 4 | −5.207E−01 | 5.624E−03 | 2.610E−03 | −1.593E−03 | 3.058E−04 | −2.818E−05 | 1.050E−06 |
| 13 | 0.000E+00 | −3.254E−04 | −1.263E−03 | 3.002E−04 | −4.293E−05 | 3.146E−06 | −9.272E−08 |
| 14 | 0.000E+00 | 7.917E−03 | −2.749E−03 | 3.019E−04 | −1.896E−05 | 6.599E−07 | −9.813E−09 |

### Fourth Numerical Example

Various Data

| Central Focal Length | 4.4 mm |
|---|---|
| Fno | 2.8 |
| Half Angle of View | ±60° |

Surface Data

| Surface | | | | |
|---|---|---|---|---|
| Number | r | d | Nd | νd |
| 1 | 35.00 | 2.00 | 1.703 | 52.4 |
| 2 | 12.18 | 0.72 | | |
| 3* | 4.75 | 1.91 | 1.583 | 59.5 |
| 4* | 2.15 | 2.98 | | |
| 5 | −6.00 | 2.00 | 1.516 | 64.1 |
| 6 | −7.23 | 0.86 | | |
| 7 | 7.97 | 1.99 | 1.652 | 58.5 |
| 8 | −10.01 | 0.20 | | |
| 9(STO) | ∞ | 1.16 | | |
| 10 | 10.24 | 3.44 | 1.618 | 63.3 |
| 11 | −3.40 | 0.60 | 1.855 | 24.8 |
| 12 | −16.79 | 1.46 | | |
| 13* | −2.57E+16 | 3.35 | 1.583 | 59.5 |
| 14* | −9.29 | 0.99 | | |
| 15 | ∞ | 0.90 | 1.560 | 56.0 |
| 16 | ∞ | 0.44 | | |

Aspherical Surface Coefficient

| Surface | | | | | | | | |
|---|---|---|---|---|---|---|---|---|
| Number | K | A | B | C | D | E | F | G |
| 3 | −1.445E+00 | 4.577E−03 | −8.192E−04 | 2.866E−05 | 2.870E−08 | −1.368E−08 | −8.878E−11 | 6.343E−12 |
| 4 | −1.163E+00 | 1.717E−02 | −3.254E−03 | −3.801E−04 | 3.013E−04 | −6.325E−05 | 6.217E−06 | −2.358E−07 |
| 13 | 0.000E+00 | 3.449E−03 | −3.316E−03 | 9.750E−04 | −1.797E−04 | 1.950E−05 | −1.166E−06 | 2.989E−08 |
| 14 | 0.000E+00 | 2.121E−02 | −7.002E−03 | 1.105E−03 | −1.086E−04 | 6.511E−06 | −2.175E−07 | 3.100E−09 |

Table 1 presents values related to the inequalities related to the optical systems according to the first to fourth embodiments. Table 1 also presents values related to inequalities (10) and (11). As illustrated in Table 1, the optical systems according to the first to fourth embodiments satisfy the inequalities.

TABLE 1

| | | First | Second | Third | Fourth |
|---|---|---|---|---|---|
| | | Embodiment | Embodiment | Embodiment | Embodiment |
| (0) | Rd | 1.00 | 1.00 | 0.90 | 1.00 |
| (1) | E1 | 0.20 | 0.24 | 0.30 | 0.22 |
| (2) | E2 | 0.84 | 0.90 | 0.90 | 0.94 |
| (3) | E3 | 0.24 | 0.22 | 0.22 | 0.26 |
| | fa1 | 21.2 | 28.5 | 33.7 | 22.6 |
| | f | 4.40 | 4.57 | 4.52 | 4.40 |
| (4) | fa1/f | 4.81 | 6.24 | 7.46 | 5.13 |
| | fG1 | 8.84 | 25.18 | 17.46 | 8.25 |
| | fG2 | 11.47 | 9.36 | 10.69 | 11.22 |
| (5) | fG1/fG2 | 0.77 | 2.69 | 1.63 | 0.74 |
| | R1 | −13.03 | −15.07 | −14.09 | −2.17E+01 |
| | R2 | −6.49 | −7.38 | −7.69 | −7.40 |
| (6) | (R2 + R1)/(R2 − R1) | −2.98 | −2.92 | −3.41 | −2.03 |
| | fLC | 19.55 | 10.01 | 11.34 | 22.44 |
| (7) | fLC/f | 4.44 | 2.19 | 2.51 | 5.10 |
| | Ds | 4.55 | 5.04 | 4.40 | 4.60 |
| | rLC | −3.47 | −3.32 | −3.2 | −3.4 |
| (8) | Ds/rLC | −1.31 | −1.52 | −1.38 | −1.35 |
| | fLL | 18.34 | 52.14 | 76.16 | 15.98 |
| (9) | fLL/f | 4.17 | 11.42 | 16.86 | 3.63 |
| (10) | f × sin(θmax)/y(θmax) | 1.13 | 1.17 | 1.15 | 1.10 |
| (11) | y(θmax/2)/y(θmax) | 0.77 | 0.78 | 0.78 | 0.67 |

### [Imaging Apparatus]

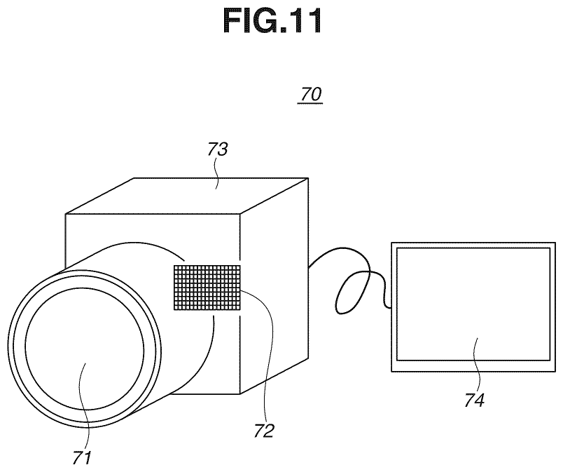

FIG. 11 is a schematic diagram illustrating main components of an imaging apparatus 70 according to an exemplary embodiment of the disclosure. The imaging apparatus 70 according to the present exemplary embodiment includes an optical system (imaging optical system) 71 according to any one of the embodiments described above, a light receiving element 72 configured to photoelectrically convert object images formed by the optical system 71, and a camera body (housing) 73 configured to hold the light receiving element 72. The optical system 71 is held by a barrel (holding member) and connected to the camera body 73. As illustrated in FIG. 11, a display unit 74 for displaying images acquired by the light receiving element 72 may be connected to the camera body 73. An image sensor (photoelectric conversion element), such as a charge-coupled device (CCD) sensor or a complementary metal oxide semiconductor (CMOS) sensor, can be used as the light receiving element 72.

In the case of using the imaging apparatus 70 as a distance measurement apparatus, for example, an image sensor (imaging plane phase difference sensor) including pixels capable of splitting a light ray from an object into two and photoelectrically converting the split beams can be employed as the light receiving element 72. In a case where a subject is on a front focal plane of the optical system 71, no positional deviation occurs in images corresponding to the two split light rays on an image plane of the optical system 71. However, in a case where the subject is outside the front focal plane of the optical system 71, a positional deviation occurs in the images. In this case, since the positional deviation in each image corresponds to the amount of displacement of the subject from the front focal plane, the distance to the subject can be measured by acquiring the amount of positional deviation in each image and the direction of each positional deviation using the imaging plane phase difference sensor.

The optical system 71 and the camera body 73 may be configured to be attachable to and detachable from each other. Specifically, the optical system 71 and the barrel may be configured as an interchangeable lens (lens apparatus). The optical systems according to the first to fourth embodiments described above are applicable to not only imaging apparatuses, such as digital still cameras, cameras for silver-halide films, video cameras, on-vehicle cameras, and monitoring cameras, but also various optical apparatuses, such as telescopes, binoculars, projectors (projection apparatuses), and digital copying machines.

### [On-Vehicle System]

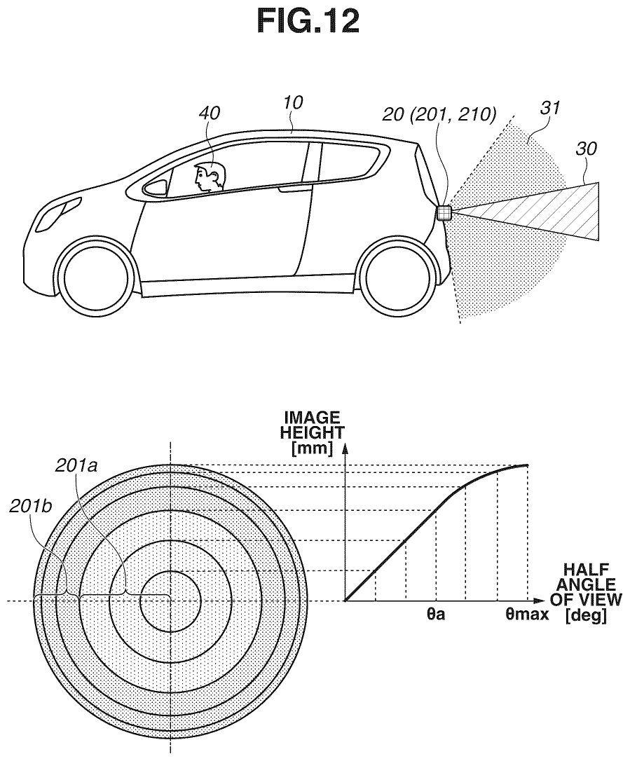

The top diagram in FIG. 12 is a schematic diagram illustrating an imaging apparatus 20 (on-vehicle camera) according to an exemplary embodiment of the disclosure and a movable apparatus 10 capable of moving while holding the imaging apparatus 20. The top diagram in FIG. 12 illustrates a case where the movable apparatus 10 is an automobile (vehicle). The movable apparatus 10 includes a driving unit (such as a motor) (not illustrated) for moving the movable apparatus 10 and an on-vehicle system (driving assistance apparatus) (not illustrated) for assisting a user 40 (such as a driver or a passenger) of the movable apparatus 10 using images acquired by the imaging apparatus 20. While the present exemplary embodiment describes a case where the imaging apparatus 20 is disposed to capture the rear of the movable apparatus 10, the imaging apparatus 20 may be disposed to capture the front or side of the movable apparatus 10. Two or more imaging apparatuses 20 may be disposed at two or more positions on the movable apparatus 10.

The imaging apparatus 20 includes an optical system 201 according to any one of the embodiments described above and an imaging unit 210. The optical system 201 is an optical system (different angle-of-view lens) with different imaging magnifications between a first angle of view (first field of view) 30 and a second angle of view (second field of view) 31 larger than the first angle of view 30. An imaging plane (light receiving surface) of the imaging unit 210 includes a first region for imaging objects within the first angle of view 30 and a second region for imaging objects within the second angle of view 31. In this case, the number of pixels per unit angle of view is greater in the first region than in the second region excluding the first region. In other words, the first angle of view 30 (first region) of the imaging apparatus 20 is higher in resolution than the second angle of view 31 (second region).

Optical characteristics of the optical system 201 will be described in detail below. The bottom left diagram in FIG. 12 illustrates image heights y [mm] at different half angles of view θ [deg.] on the imaging plane of the imaging unit 210 in the form of contour lines. The right bottom diagram in FIG. 12 illustrates the relationship (projection characteristic of the optical system 201) between the half angles of view θ and the image heights y in the first quadrant of the left diagram in the form of a graph.

As illustrated in the bottom diagram in FIG. 12, the optical system 201 is configured so that projection characteristics y(θ) for angles of view smaller than a predetermined half angle of view θa and projection characteristics y(θ) for angles of view greater than or equal to the half angle of view θa overlap Thus, the amount of increase in image height y per unit of half angle of view θ (resolution) varies for each angle of view. A local resolution of the optical system 201 is expressed as a derivative value dy(θ)/dθ of the projection characteristic y(θ) with respect to the half angle of view θ. The left bottom diagram in FIG. 12 indicates that the greater the spacing between the contour lines of the image height y with respect to the half angle of view θ, the higher the resolution. The right bottom diagram in FIG. 12 indicates that the greater the slope of the graph of the projection characteristic y(θ), the higher the resolution.

In the left bottom diagram in FIG. 12, a first region 201a is a central region and corresponds to the angles of view less than the half angle of view θa, and a second region 201b is a peripheral region and corresponds to the angles of view greater than or equal to the half angle of view θa. The angles of view less than the half angle of view θa correspond to the first angle of view 30 in the top diagram in FIG. 12, and the angles of view less than the half angle of view θa and the angles of view greater than or equal to the half angle of view θa in combination correspond to the second angle of view 31 in the top diagram in FIG. 12. As described above, the first region 201a is a high-resolution, low-distortion region, and the second region 201b is a low-resolution, high-distortion region.

In one embodiment, the value of the half angle of view θa is greater than or equal to 13.5° and less than or equal to 31.5°, in another embodiment, greater than or equal to 14.4° and less than or equal to 22.5°.

The optical system 201 is configured so that the projection characteristic y(θ) in the first region 201a differs from f×θ (equidistant projection method) and from the projection characteristic in the second region 201b. In this case, the projection characteristic y(θ) of the optical system 201 satisfies the following inequality (10):

$$1. < f \times sin ( θmax ) / y ( θmax ) \leq 1.9 . \qquad ( 10 )$$

By satisfying inequality (10), the resolution is reduced in the second region 201b, so thus realizing a wide angle of view of the optical system 201. Furthermore, a higher resolution is realized in the first region 201a than in a central region of a general fisheye lens that employs an orthographic projection method (y(θ)=f×sin θ). Falling below the lower limit of inequality (10) is undesirable because it may lead to lower resolution in the first region 201a as compared with the fisheye lens of the orthographic projection method or increased maximum image height, resulting in increase in the optical system size. Exceeding the upper limit of inequality (10) is also undesirable because it may lead to excessively high resolution in the first region 201a, which makes it difficult to realize a wide angle of view equivalent to that of the fisheye lens of the orthographic projection method or maintain excellent optical performance.

Furthermore, in one embodiment, the following inequality (10a) is satisfied:

$$1. < f \times sin ( θmax ) / y ( θmax ) \leq 1.7 . \qquad ( 10 a )$$

In another embodiment, the following inequality (10b) is satisfied:

$$1. < f \times sin ( θmax ) / y ( θmax ) \leq 1.4 . \qquad ( 10 b )$$

In one embodiment, the optical system according to the present exemplary embodiment satisfies the following inequality (11):

$$0.55 < y ( θmax / 2 ) / y ( θmax ) < 0.85 . \qquad ( 11 )$$

Inequality (11) represents the value of the ratio of the image height y(θmax/2) at the angle of view θmax/2, which is half of the maximum half angle of view θmax, to the image height y(θmax) at the maximum half angle of view θmax. By satisfying inequality (11), a higher resolution is achieved near the optical axis OA in the first region 201a while maintaining a wide angle of view. Failing to satisfy inequality (11) is undesirable because it may lead to a lower resolution in the first region 201a as compared with the fisheye lens of the orthographic projection method or may make it difficult to achieve a wide angle of view equivalent to that of the fisheye lens of the orthographic projection method.

Furthermore, in another embodiment, the following inequality (11a) is satisfied:

$$0.6 < y ( θmax / 2 ) / y ( θmax ) < 0.83 . \qquad ( 11 a )$$

In yet another embodiment, the following inequality (11b) is satisfied:

$$0.65 < y ( θmax / 2 ) / y ( θmax ) < 0.81 . \qquad ( 11 b )$$

As described above, since the first region 201a of the optical system 201 is low in distortion and high in resolution, high-resolution images are obtainable as compared with the second region 201b. Thus, excellent visibility is achievable by setting the first region 201a (the first angle of view 30) to a region of interest of the user 40. For example, in a case where the imaging apparatus 20 is disposed at a rear portion of the movable apparatus 10 as illustrated in the top diagram in FIG. 12, displaying an image corresponding to the first angle of view 30 on an electronic rearview mirror allows the user 40 to obtain a natural sense of perspective when the user gases at a rear vehicle. In contrast, the second region 201b (the second angle of view 31) corresponds to a wide angle of view including the first angle of view 30. Thus, for example, displaying an image corresponding to the second angle of view 31 on an in-vehicle display while the movable apparatus 10 is reversing assists the user 40 in driving.

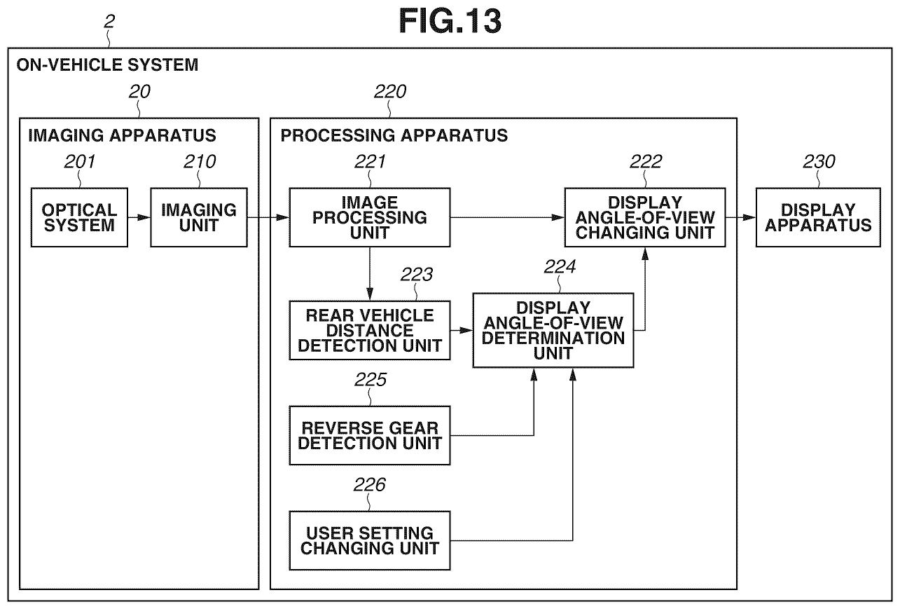

FIG. 13 is a functional block diagram illustrating an example of a configuration of an on-vehicle system (display system) 2 according to the present exemplary embodiment. The on-vehicle system 2 is a system displaying images acquired by the imaging apparatus 20 positioned behind the movable apparatus 10, to the user 40. The on-vehicle system 2 includes the imaging apparatus 20, a processing apparatus 220, and a display apparatus (display unit) 230. The imaging apparatus 20 includes the optical system 201 and the imaging unit 210 as described above. The imaging unit 210 includes an image sensor, such as a CCD sensor or a CMOS sensor, photoelectrically converts optical images formed by the optical system 201 to generate captured image data, and outputs the captured image data to the processing apparatus 220.

The processing apparatus 220 includes an image processing unit 221, a display angle-of-view determination unit 224 (determination unit), a user setting changing unit 226 (first changing unit), a rear vehicle distance detection unit 223 (first detection unit), a reverse gear detection unit 225 (second detection unit), and a display angle-of-view changing unit 222 (second changing unit). The processing apparatus 220 is a computer such as a central processing unit (CPU) microcontroller and functions as a control unit that controls the operation of each component based on computer programs. At least one component of the processing apparatus 220 may be realized by hardware such as an application specific integrated circuit (ASIC) or a programmable logic array (PLA).

The image processing unit 221 generates image data by performing image processing, such as wide dynamic range (WDR) correction, gamma correction, look up table (LUT) processing, and distortion correction, on the captured image data acquired from the imaging unit 210. The distortion correction is performed at least on the captured image data that corresponds to the second region 201b. This makes it easier for the user 40 to visually recognize an image displayed on the display apparatus 230 and, furthermore, improves the detection rate of rear vehicles by the rear vehicle distance detection unit 223. Performing distortion correction on the captured image data that corresponds to the first region 201a may be omitted. The image processing unit 221 outputs the image data generated by performing the above-described image processing to the display angle-of-view changing unit 222 and the rear vehicle distance detection unit 223.

The rear vehicle distance detection unit 223 acquires information about a distance to a rear vehicle included in image data corresponding to a range that is within the second angle of view 31 but does not include the first angle of view 30, using the image data output from the image processing unit 221. For example, the rear vehicle distance detection unit 223 is capable of detecting a rear vehicle based on the image data that corresponds to the second region 201b and calculating a distance from the rear vehicle to the vehicle including the on-vehicle system 2 based on changes in position and size of the detected rear vehicle. The rear vehicle distance detection unit 223 outputs the calculated distance information to the display angle-of-view determination unit 224.

Furthermore, the rear vehicle distance detection unit 223 may determine the vehicle type of the rear vehicle based on feature information data, such as shape and color, for each vehicle type that is output as a result of machine learning (deep learning) based on a large number of vehicle images. In this case, the rear vehicle distance detection unit 223 may output the vehicle type information about the rear vehicle to the display angle-of-view determination unit 224. The reverse gear detection unit 225 detects whether a transmission of the movable apparatus 10 (the vehicle including the on-vehicle system 2) is in reverse gear and outputs the detection result to the display angle-of-view determination unit 224.

The display angle-of-view determination unit 224 determines which one of the first angle of view 30 and the second angle of view 31 is to be set as an angle of view (display angle-of-view) of the image to be displayed on the display apparatus 230, based on the output from at least one of the rear vehicle distance detection unit 223 and the reverse gear detection unit 225. The display angle-of-view determination unit 224 outputs to the display angle-of-view changing unit 222 based on the determination result. For example, in a case where a distance value in the distance information becomes equal to or less than a threshold (e.g., 3 m), the display angle-of-view determination unit 224 determines to set the display angle-of-view to the second angle of view 31, whereas in a case where the distance value exceeds the threshold, the display angle-of-view determination unit 224 determines to set the display angle-of-view to the first angle of view 30. Further, the display angle-of-view determination unit 224 may determine to set the display angle-of-view to the second angle of view 31 in a case where a notification indicating that the transmission of the movable apparatus 10 is in reverse gear is received from the reverse gear detection unit 225. In a case where the transmission is not in reverse gear, the display angle-of-view determination unit 224 may determine to set the display angle-of-view to the first angle of view 30.

Furthermore, in the state where the transmission of the movable apparatus 10 is in reverse gear, the display angle-of-view determination unit 224 may determine to set the display angle-of-view to the second angle of view 31 irrespective of the result of the rear vehicle distance detection unit 223. In a case where the transmission of the movable apparatus 10 is not in reverse gear, the display angle-of-view determination unit 224 may determine to set the display angle-of-view based on the detection result of the rear vehicle distance detection unit 223. The display angle-of-view determination unit 224 may change determination criteria for determining whether to change the angle of view based on the vehicle type of the movable apparatus 10 by receiving vehicle type information from the rear vehicle distance detection unit 223. For example, in a case where the movable apparatus 10 is a large-sized vehicle, such as a truck, since the braking distance is longer than those of regular-sized vehicles, in one embodiment, the threshold is set to be longer (e.g., 10 m) than those for regular-sized vehicles.

The user setting changing unit 226 enables the user 40 to change the determination criteria for determining whether to change the display angle-of-view to the second angle of view 31 by the display angle-of-view determination unit 224. The determination criteria that are set (changed) by the user 40 are input from the user setting changing unit 226 to the display angle-of-view determination unit 224.

The display angle-of-view changing unit 222 generates a display image to be displayed on the display apparatus 230 based on the determination result of the display angle-of-view determination unit 224. For example, in a case where the first angle of view 30 is determined to be set, the display angle-of-view changing unit 222 crops a rectangular narrow-angle image (first image) from the image data corresponding to the first angle of view 30 and outputs the cropped image to the display apparatus 230. In a case where a rear vehicle that satisfies predetermined conditions is present in the image data corresponding to the second angle of view 31, the display angle-of-view changing unit 222 outputs an image (second image) including the rear vehicle to the display apparatus 230. The second image may include an image corresponding to the first region 201a. The display angle-of-view changing unit 222 functions as a display control unit that performs display control to switch between a first display state in which the display apparatus 230 displays the first image and a second display state in which the display apparatus 230 displays the second image.

The display angle-of-view changing unit 222 performs image cropping by storing the image data output from the image processing unit 221 in a storage unit (memory), such as a random access memory (RAM), and then reading an image to be cropped from the stored image data. The region that corresponds to the first image in the image data is the rectangular region within the first angle of view 30 corresponding to the first region 201a. The region that corresponds to the second image in the image data is the rectangular region including the rear vehicle within the second angle of view 31 corresponding to the second region 201b.

The display apparatus 230 includes a display unit, such as a liquid crystal display or an organic electroluminescent (organic EL) display, and displays a display image output from the display angle-of-view changing unit 222. For example, the display apparatus 230 includes a first display unit serving as an electronic rearview mirror positioned at an upper side of a windshield (front glass) of the movable apparatus 10 and a second display unit serving as an operation panel (monitor) positioned at a lower side of the windshield of the movable apparatus 10. This configuration makes it possible to display the first and second images generated from the image data on the first and second display units, respectively. The first display unit may include, for example, a semi-transparent mirror so that the first display unit is used as a mirror when not being used as a display. The second display unit may also be used as a display of, for example, a navigation system or an audio system.

The movable apparatus 10 is not limited to a vehicle, such as an automobile and may be a movable object, such as a ship, aircraft, industrial robot, or drone. The on-vehicle system 2 according to the present exemplary embodiment is used for displaying images to the user 40. However, this is not a limitation, and the on-vehicle system 2 may be used for driving assistance, such as cruise control (including full-range adaptive cruise control) or autonomous driving. Furthermore, the on-vehicle system 2 is applicable to not only movable apparatuses but also various devices that use object recognition, such as intelligent transportation systems (ITS).

### MODIFIED EXAMPLES

Various exemplary embodiments and embodiments of the disclosure have been described above. However, the disclosure is not limited to the exemplary embodiments and embodiments, and various combinations, modifications, and alterations can be made without departing from the scope of the disclosure.

For example, the optical systems according to the embodiments described above are intended for use in the visible range and are configured to perform suitable aberration correction over the entire visible range. However, as appropriate, the wavelength range for which aberration correction is performed may be changed. For example, each optical system may be configured to perform aberration correction exclusively for a specific wavelength range within the visible range, or may be configured to perform aberration correction in the infrared range excluding the visible range.

The on-vehicle system 2 may employ the above-described distance measurement apparatus as the imaging apparatus 20. In this case, the on-vehicle system 2 may include a determination unit for determining the possibility of a collision with an object based on information about a distance to the object that is obtained by the imaging apparatus 20.

A stereo camera that includes two imaging units 210 may be employed as the imaging apparatus 20. In this case, processes similar to those described above can be performed without using an imaging plane phase difference sensor, by simultaneously acquiring image data with the synchronized imaging units 210 and using the two pieces of image data. However, the imaging units 210 does not have to be synchronized if the difference in imaging time between the imaging units 210 is known.

This application claims the benefit of Japanese Patent Application No. 2023-204960, filed Dec. 4, 2023, which is hereby incorporated by reference herein in its entirety.

What is claimed is:

1. An optical system comprising, in order from an object side to an image side:
a front group with positive refractive power;
an aperture stop; and
a rear group with positive refractive power,
wherein the front group includes, in order from the object side to the image side, a first lens with negative refractive power, a second lens with negative refractive power, a third lens, and a fourth lens with positive refractive power,
wherein the rear group includes a cemented lens and a meniscus lens disposed closest to an image plane,
wherein at least one of an object-side surface and an image-side surface of the meniscus lens is an aspherical surface,
wherein a spherical surface passing through both edge portions in an effective region of the object-side surface has a concave shape toward the object side in a cross-section including an optical axis, and
wherein the following inequality is satisfied:
0.80≤Rd≤1.00,
where Rd is a value of a ratio of a diameter of a portion that has positive power in an effective region of the image-side surface to a diameter of the effective region of the image-side surface in a direction perpendicular to the optical axis.

2. The optical system according to claim 1, wherein the object-side surface of the meniscus lens is an aspherical surface.

3. The optical system according to claim 1, wherein an object-side surface of the second lens is an aspherical surface including an inflection point in the cross-section including the optical axis.

4. The optical system according to claim 3, wherein a graph representing a curvature of the object-side surface of the second lens with respect to a radial position in the cross-section including the optical axis includes a first extremum, and the following inequality is satisfied:
0.05≤E1≤0.50,
where E1 is a normalized distance from the optical axis to a position corresponding to the first extremum.

5. The optical system according to claim 4, wherein the graph includes a second extremum, and the following inequality is satisfied:
0.60≤E2≤0.98,
where E2 is a normalized distance from the optical axis to a position corresponding to the second extremum.

6. The optical system according to claim 1, wherein a graph representing a curvature of the image-side surface of the meniscus lens with respect to a radial position in the cross-section including the optical axis includes a third extremum, and the following inequality is satisfied:
0.05≤E3≤0.50,
where E3 is a normalized distance from the optical axis to a position corresponding to the third extremum.

7. The optical system according to claim 1, wherein the following inequality is satisfied:
$$3.5 \leq fa 1 / f \leq 10.0 ,$$
where fa1 is a focal length of an air lens between the first lens and the second lens, and f is a focal length of the optical system.

8. The optical system according to claim 1, wherein the following inequality is satisfied:
$$0.4 \leq fG 1 / fG 2 \leq 3.5 ,$$
where fG1 is a focal length of the front group, and fG2 is a focal length of the rear group.

9. The optical system according to claim 1, wherein the following inequality is satisfied:
$$- 1.5 \leq ( R 2 + R 1 ) / ( R 2 - R 1 ) \leq - 4. ,$$
where R1 is a radius of curvature of the spherical surface passing through the both edge portions in the effective region of the object-side surface of the meniscus lens, and R2 is a radius of curvature of a spherical surface passing through both edge portions in the effective region of the image-side surface of the meniscus lens.

10. The optical system according to claim 1, wherein the following inequality is satisfied:
$$1. \leq fLC / f \leq 6. ,$$
where fLC is a focal length of the cemented lens, and f is a focal length of the optical system.

11. The optical system according to claim 1, wherein the following inequality is satisfied:
$$- 2.2 \leq Ds / rLC \leq - 0.6 ,$$
where rLC is a radius of curvature of a bonding surface of the cemented lens, and Ds is a distance from the aperture stop to the bonding surface.

12. The optical system according to claim 1, wherein the following inequality is satisfied:
$$2. \leq fLL / f \leq 22. ,$$
where fLL is a focal length of the meniscus lens, and f is a focal length of the optical system.

13. The optical system according to claim 1, wherein on the optical axis, the first lens and the second lens each have a convex meniscus shape toward the object side, the third lens has a concave shape toward the object side, and the fourth lens has a biconvex shape.

14. The optical system according to claim 1, wherein the cemented lens includes a positive lens and a negative lens in order from the object side to the image side, and on the optical axis, the positive lens has a biconvex shape, and the negative lens has a convex meniscus shape toward the image side.

15. The optical system according to claim 1, wherein the following inequality is satisfied:
$$1. < f \times sin ( θmax ) / y ( θmax ) \leq 1.9 ,$$
where y(θ) is a projection characteristic of the optical system that represents a relationship between a half angle of view θ and an image height y, θmax is a maximum half angle of view of the optical system, and f is a focal length of the optical system.

16. The optical system according to claim 1, wherein the following inequality is satisfied:
$$0.65 < y ( θmax / 2 ) / y ( θmax ) < 0.85 ,$$
where y(θ) is a projection characteristic of the optical system that represents a relationship between a half angle of view θ and an image height y, and θmax is a maximum half angle of view of the optical system.

17. An apparatus comprising the optical system according to claim 1 and a sensor configured to capture an image of an object through the optical system.

18. A display system comprising the apparatus according to claim 17 and a display apparatus configured to display an image obtained based on an output from the apparatus.

19. The display system according to claim 18, wherein the display apparatus includes a first display unit configured to display a first region of the image corresponding to a first angle of view and a second display unit configured to display a second region of the image corresponding to a second angle of view including the first angle of view.

20. A movable apparatus comprising the apparatus according to claim 17 and configured to move while holding the apparatus.
